(19) United States
(12) Patent Application Publication
(10) Pub. No.: US 2026/0054330 A1
(43) Pub. Date: Feb. 26, 2026

(54) ELECTROMAGNETIC-BASED ULTRASONIC RESIDUAL STRESS RELIEVING SYSTEM

(71) Applicant: X-wave Innovations, Inc., Gaithersburg, MD (US)

(72) Inventors: Dan Xiang, Gaithersburg, MD (US); DHEERAJ VELICHETI, Gaithersburg, MD (US); HUNTER JONES, Gaithersburg, MD (US); ADAM HARWOOD, Gaithersburg, MD (US)

(73) Assignee: X-wave Innovations, Inc., Gaithersburg, MD (US)

(21) Appl. No.: 18/959,509

(22) Filed: Nov. 25, 2024

Related U.S. Application Data
(60) Provisional application No. 63/686,678, filed on Aug. 23, 2024.

(51) Int. Cl. B23K 37/06

(52) U.S. Cl. CPC B23K 37/06

(57) ABSTRACT

An electromagnetic-based ultrasonic residual stress relief system and process for welds on metal surfaces can include a latching switch for high voltage charging that controls current from the capacitor charging module to the high voltage capacitor, a non-latching switch for spark-gap trigger that can control current from a spark-gap trigger module to a spark-gap trigger circuit. The non-latching switch for spark-gap trigger can discharge energy from the high-pulsed current capacitor into the spark-gap circuit, which can discharge energy into a coil that can be moved over the weld zone. The large AC current induced high-frequency, small-amplitude through-thickness ultrasonic vibration yields residual stress relief in the weld and HAZ region.

### CROSS-REFERENCE TO RELATED APPLICATIONS

This application claims the benefit of U.S. Provisional Application Ser. No. 63/686,678 filed on Aug. 23, 2024.

### STATEMENT REGARDING FEDERALLY SPONSORED RESEARCH OR DEVELOPMENT

This invention was made with government support under DE-SC0020845 awarded by the U.S. Department of Energy. The government has certain rights in the invention.

### FIELD OF INVENTION

The present embodiments are directed to the technical field of residual stress-relieving systems and processes. More particularly, the present embodiments are in the field of electromagnetic systems for generating local through-thickness ultrasonic vibrations to relieve the residual stress in weld and heat-affected zones (HAZ) of a metal.

### BACKGROUND

Vibration-based methods are traditionally used to remove residual stress in welds and HAZ. Ultrasonic residual stress relief employs ultrasonic oscillations that generate oscillatory stresses and are applied to the surface of a metal, inducing volume effects, including both the reduction of yield stress and plastic deformation of the sample surface. The former directly contributes to the residual stress relief by both permanent effects like change in the distribution of the dislocations, and temporary effects like stress superposition and acoustic softening via thermal activation. Recent experiments have also shown that this softening is maintained even when the ultrasonic excitation is stopped, and residual stress in metal sheets was successfully reduced by using ultrasonic vibrations. Due to the significant reduction in energy consumption in comparison with conventional techniques and some unique effects associated with the ultrasonic method, the application of ultrasonic vibration is increasing progressively in several industrial activities.

Such residual stress-relieving processes generally rely on contact-based methods using piezo-based transducers. These contact-based methods require large forces to back the transducers and generate a lot of sound and heat. This makes the treatment from contact-based transducers suffer from large variations in terms of the amount of residual stress relieved.

### SUMMARY

To overcome the limitations of the contact-based ultrasonic residual stress relief methods, the present disclosure makes use of a non-contact electromagnetic method that can generate ultrasonic vibrations in a weld zone. One application for the embodiments is for use on weld zones on spent nuclear fuel dry storage canisters (DSC). Other applications can include electromagnetic peening, and electromagnetic forming and for developing electromagnetic acoustic transducers (EMATs) for nondestructive and structural health monitoring. The amount of energy that is required to generate vibrations for stress relief is significantly different from other applications. Stress relieving requires significantly lower energy levels compared to electromagnetic forming and electromagnetic peening but significantly higher than energy levels required for EMATs.

### BRIEF DESCRIPTION OF THE DRAWINGS

The present embodiments are better understood by reference to the following detailed description when considered in connection with the accompanying drawing, wherein:

FIG. 1 shows a schematic with an exemplary electromagnetic-based ultrasonic residual stress relief system of the embodiments;

FIG. 2 is an exemplary functional flowchart with steps (A), (B), (C) and (D) illustrating how large currents injected into a coil placed over a metal surface generate vibrations in the metal component; large currents are injected into the coil when the energy in the capacitor is discharged into the coil, (A); the current in the coil generates a magnetic field, (B), which induces eddy currents in the metal surface below, (C); the resulting interaction between the eddy currents and the magnetic fields generates Lorentz forces, (D);

FIG. 3 shows a normalized flux density and magnetic pressure plot in time of the embodiments;

FIG. 4 shows the results from COMSOL electromagnetic simulations highlighting the magnetic flux density distribution around a coil with 25 and 50 turns placed 1 mm above a steel plate and injected with 2 kA of current at 20 kHz of the embodiments;

FIG. 5 is a plot highlighting how the magnetic pressure under a coil placed above a steel plate at four different lift-off heights, injected with 2 kA of current at 20 kHz, changes with an increasing number of coil turns of the embodiments;

FIG. 6 is a plot highlighting how the magnetic pressure under a coil placed 1 mm above a steel plate changes with an increasing number of coil turns for two injected current levels, 4 kA, and 8 kA of the embodiments;

FIG. 7 is a schematic of an exemplary EM-URSR cart positioned for processing the longitudinal weld of a dry storage canister (where a weld extends normal to the plane of the page), and an isometric view of the EM-URSR cart situated above a longitudinal weld on a DSC section of the embodiments;

FIG. 8 shows a more detailed view of a coil element and backing components of the embodiments;

FIG. 9 shows a section view of an exemplary EM-URSR cart assembly with the coil in the retracted position of the embodiments;

FIG. 10 shows a section view of an exemplary EM-URSR cart assembly with the coil in the lowered position of the embodiments;

FIG. 11 shows a simplified block diagram of an exemplary EM-URSR system when the (A) capacitor is being charged and (B) capacitor is being discharged into a coil of the embodiments; and

FIG. 12 is an exemplary schematic that compares the gas type estimated by tracking shift in frequency peaks of the signal from an LC-sensor to the actual case of the embodiments.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. The present disclosure is to be considered as an exemplification of the invention and is not intended to limit the invention to the specific embodiments illustrated by the figures or description herein.

Various embodiments of the present invention may incorporate one or more of these and the other features described herein. The following detailed description taken in conjunction with the accompanying drawings may provide a better understanding of the nature and advantages of the present invention. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. While the invention has been described with a certain degree of particularity, it is manifest that many changes may be made in detail of construction and the arrangement of components without departing from the spirit and scope of this disclosure. The present disclosure is to be considered as an exemplification of the principles of the invention and is not intended to limit the invention to the specific embodiments illustrated herein by the figures or description above.

To overcome the shortcomings of the prior art, a new and novel system and a method have been designed for electromagnetic residual stress relieving of metal weld zones. One embodiment can be used in stress relieving steel weld zones in DSC waste canisters. The non-contact nature of the system makes the embodiments more efficient and easy-to-deploy for reducing the residual stress levels in weld zones. Additionally, the exemplary system and method can be modified to work on metals such as, but not limited to, aluminum which is electrically more conductive compared to steel. The present embodiments can include an electromagnetic residual stress relieving system and process, which can include a movable cart used to deploy a copper coil above the weld zone, a high-pulsed-current rated capacitor, a very high voltage capacitor charger, and a spark-gap based circuit to discharge the energy stored in the capacitor into the coil.

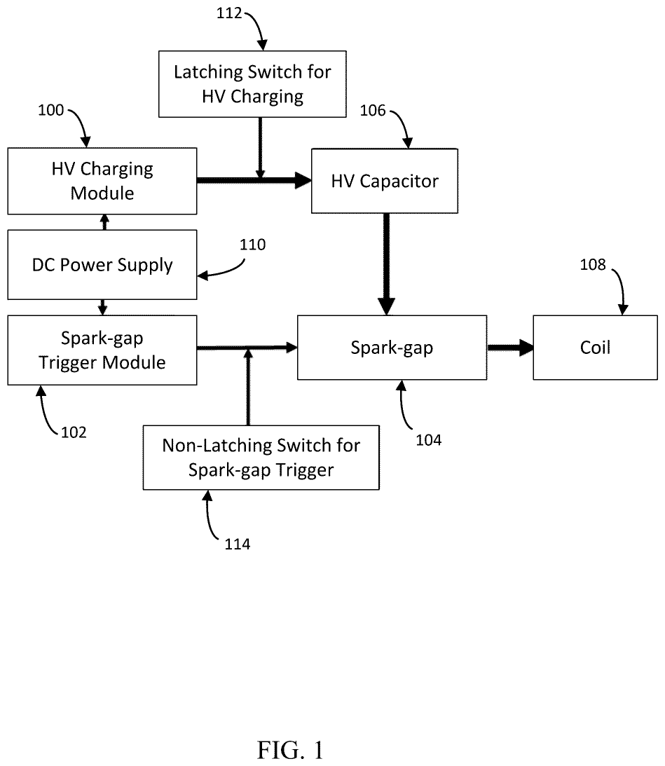

FIG. 1 shows a schematic with an embodiment for an electromagnetic-based ultrasonic residual stress relief (EM-URSR) system overview, highlighting the major components of the exemplary system. The components of the exemplary EM-URSR system can include a high-voltage capacitor charger 100, a triggered spark-gap module 102, a spark-gap trigger circuit 104, a high-pulsed-current capacitor 106, and a coil 108. In other embodiments, not all components need to be separate, and some may be combined as single modules or units that serve the same function. In an embodiment, a DC Power charging supply 110 can be used to charge the high-voltage charging module 100, which can then charge the high-voltage capacitor 106 and the spark-gap trigger module 102. In one embodiment, the DC power supply 110 is a 24V DC charging supply. Other charging supply voltages can be used in charging supply 110, for example a 20V DC voltage, depending on the application. In other embodiments, a latching switch for high-voltage charging 112 can be used to control current from the high-voltage charging module 100 to the high-voltage/high-pulsed-current capacitor 106. A non-latching switch for spark-gap trigger 114 can be used to control the current from the spark-gap trigger module 102 to the spark gap spark-gap trigger circuit 104.

The exemplary EM-URSR system and method of the embodiments can rely upon the Lorentz force mechanism to generate mechanical vibrations in metal components. In an embodiment, an EM-URSR system can include a high-voltage capacitor and a planar coil. First, the capacitor is charged up to voltage levels of 20 kV, and then the energy in the capacitor is discharged into a planar coil placed above the weld zone. The high-current pulse through the coil results in large Lorentz forces due to the dynamic interaction between the magnetic field around the coil and the eddy currents induced in the metal component below.

In the embodiments, an EM-URSR system is disclosed that can relieve residual stress in nuclear fuel dry storage canisters (SNF-DSC) in a highly efficient, controllable, and repeatable manner. Large AC currents (>5 kA) can be injected into the coil 108 to produce high-frequency (e.g., ≈20 kHz), small-amplitude through-thickness ultrasonic vibration in a weld and HAZ region. It should be noted that in other embodiments the frequency may vary higher or lower without deviating from the invention. These localized ultrasonic vibrations significantly increase the effectiveness and efficiency and reduce processing time, for residual stress relief in the weld and HAZ, compared to traditional resonant vibration stress relief techniques.

In an embodiment, the electromagnetic-based ultrasonic residual stress relief (EM-URSR) system of the embodiments can include, but is not limited to, a high-current pulse capacitor 106, a 20 kV capacitor charging circuit 100, a very high-power switching system 112, and a copper coil 108. The system relies on the energy stored in the capacitor 106 to be released into the coil 108 placed over a weld zone within a very short period using the high-power switching system 112 to generate through-thickness ultrasonic vibrations in the weld zone.

First, in an embodiment the EM-URSR 100 can include a single flyback transformer, which can be used to charge high-pulsed-current capacitors up to 20 kV. Second, the exemplary non-latching triggered spark-gap-based switch 114 can be capable of discharging capacitors charged up to 20 kV, generating current pulses in the 10-50 kA (peak-to-peak) range. The triggered spark gap circuit 104 can be a commercially available unit. The spark-gap trigger module 102 is based on a flyback transformer that can generate the trigger pulse for the spark gap 104.

During the processing of a weld zone, the HV capacitor 106 is first charged to high voltages greater than 10 kV, although other voltages are possible depending on the application and fall within the scope of the invention. Next, using the non-latching switch for spark-gap trigger 114, the energy in the HV capacitor 106 can be discharged into the coil 108 almost instantaneously. The exemplary process generates very large electromagnetic fields around the coil 108, which in turn induces eddy currents in a weld zone below the coil. The frequency of the magnetic fields around the coil 108 and the eddy currents induced in a steel plate the coil are a function of the inductance of the coil 108 and the capacitance values of the high pulsed current capacitor 106. The dynamic interaction between the magnetic field around the coil 108 and the eddy currents induced in a weld zone below results in Lorentz forces, i.e., mechanical vibrations. The frequency of the mechanical vibrations generated can be double that of the frequency of the current injected into the coil 108 and will have positive polarity exclusively.

The process described above can generate through-thickness vibrations with a peak-to-peak amplitude of >2 μm, which effectively reduces the residual stress in a weld zone.

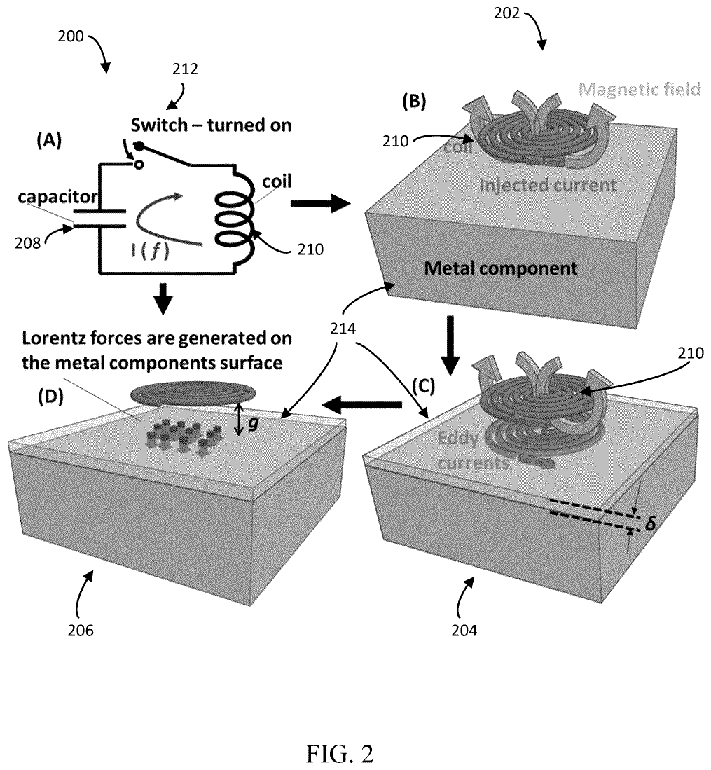

Some embodiments, as previously mentioned, are designed to relieve the residual stress in a weld and a HAZ zone of steel canisters used for nuclear waste storage. FIG. 2 is an exemplary functional flowchart with steps (A), (B), (C) and (D) illustrating how large currents injected into a coil placed over a metal surface generate vibrations in the metal component; large currents are injected into the coil when the energy in the capacitor is discharged into the coil, (A); the current in the coil generates a magnetic field, (B), which induces eddy currents in the metal surface below, (C); the resulting interaction between the eddy currents and the magnetic fields generates Lorentz forces, (D). FIG. 2 highlights the physics behind an exemplary EM-URSR system. In the chart, step A (200) includes charged high-voltage, high-pulsed-current capacitor that is discharged into a coil placed distance (g) (step D) (206) above a metal surface. Given a capacitor 208 with capacitance C and charged to voltage U, the stored energy E in the capacitor 208 is

$$E = \frac{1}{2} {CU}^{2} .$$

The energy in the inductor is given by

$$E = \frac{1}{2} {LI}_{el}^{2} ,$$

where L is the inductance of the coil and let is the current flowing through the coil.

After closing a switch, the capacitor C 208 will rapidly (within Oct. 4, 2010-3 s) discharge into an inductor L 210. The arrangement represents an L-C-oscillation circuit; the current in the conductor (and the associated magnetic field) then will oscillate with a characteristic frequency f. The characteristic electrical impedance Zer is the ratio of voltage amplitude and current amplitude in the oscillating L-C-circuit

$$f = \frac{1}{2 π \sqrt{L \cdot C}} ,$$

$${Z}_{el} = \sqrt{\frac{L}{C}} .$$

The available maximum electrical power P_{el.max} from such oscillating L-C-circuit is:

$${P}_{el , max} = \frac{1}{4} \cdot \frac{{U}^{2}}{{Z}_{el}} = \frac{1}{4} \frac{1}{\sqrt{LC}} {CU}^{2} = π fE .$$

In practical setups, neither the coil 210 nor the switch 212 nor the capacitor 208 is ideal. The energy losses and resistance of these elements result into a damped oscillation of the current or the magnetic flux density B

$$B ( t ) ∼ sin ( 2 π ft ) {e}^{- \frac{t}{τ}} ,$$

where τ=L/R and R is an equivalent series resistance in the L-C circuit after the switch 212 closes. The schematic in FIG. 2(B) (202) shows a current injection into coil 210 and a magnetic field generated.

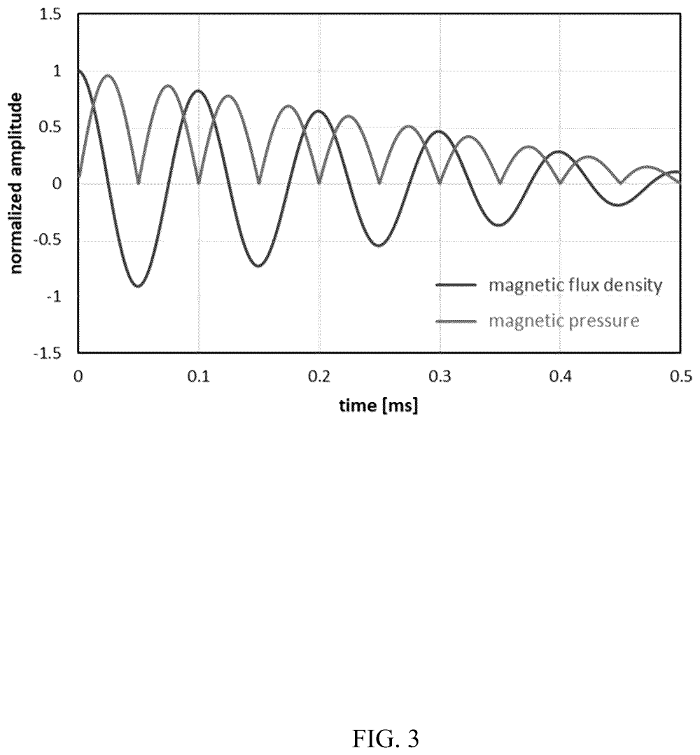

The magnetic field induces eddy currents running in the opposite direction to the current in the coil 210 as shown in FIG. 2(C) (204). The interaction between the annular eddy current and the mostly radial magnetic field, both running parallel to the metal surface within the surface sheet (δ) of the metal test object, results in Lorentz forces. These distributed forces are directed normally into the depth, as shown in FIG. 2(D) (206), and are experienced as a pressure p. The pressure is positive for both the positive and negative half-wave of the oscillating magnetic field, as shown in FIG. 3. This means when both the B field and the accompanying eddy current periodically change the polarity, only positive pressure is produced. Consequently, the Lorentz forces or pressure will then oscillate at a doubled frequency. Furthermore, the Lorentz force is proportional to the magnetic flux density B and the eddy currents, which itself is proportional to B. Then the Lorentz force and the experienced pressure is proportional to B². It is further known in disciplines like magnetohydrodynamics that this experienced pressure p actually equals the energy density of an oscillating or transient magnetic field parallel and in contact with a metallic surface:

$$p = \frac{1}{2} \frac{{B}^{2}}{{μ}_{0}} ,$$

where μ₀ represents the magnetic permeability of the vacuum. The energy density of a magnetic field is, therefore, also denoted as the magnetic pressure p. For acoustics, the information regarding the magnetic pressure p or the magnetic flux density B in vicinity to a good conductor is sufficient and does not require a more detailed and complex determination of eddy currents and finally resulting Lorentz forces. Further, since most of the pressure is directed normally into the depth of the metal, a preferred excitation of longitudinal waves, propagating normally into the depth, can be expected. The effective sound intensity I of an ultrasound wave at sound pressure p (peak value) in a material is

$$I = \frac{{p}^{2}}{2 \cdot {Z}_{M}} ,$$

where Z_{M} is the characteristic acoustic impedance. The excited sound intensity I should increase with B⁴ or the stored energy E², a quadratic effect or an effect of second order. This means when a coil injected with large currents is used to generate high-intensity ultrasound waves in metals, the ultrasound power should increase with the square of excitation power.

Furthermore, the transmitted ultrasound power P_{US} of the ringing LC-circuit with released energy E, lift-off g and coil area A over a metal with acoustic impedance Z_{M} is given by

$${P}_{US} = {( \frac{E}{gA} \cdot \frac{1}{2} \cdot \frac{1}{2} )}^{2} ( \frac{1}{2 {Z}_{M}} ) A .$$

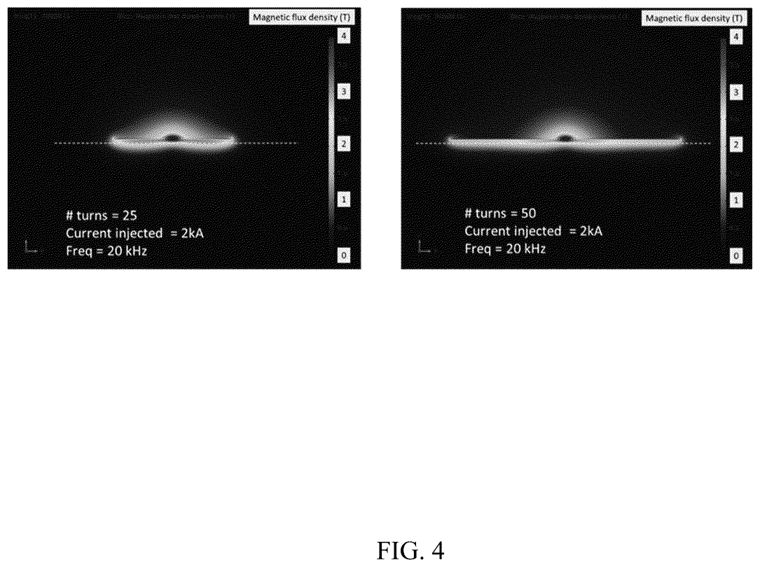

FIG. 4 shows the results from electromagnetic simulation software highlighting the magnetic flux density distribution around a coil with 25 and 50 turns placed 1 mm above a steel plate and injected with 2 kA of current at 20 kHz using simulated parameters of the system and an exemplary process of the embodiments. These simulations highlight the fact that peak pressure, for a planar coil, occurs at the center of the coil. Therefore, increasing the number of turns for the coil to increase the average magnetic pressure generated has an upper limited threshold of functionality.

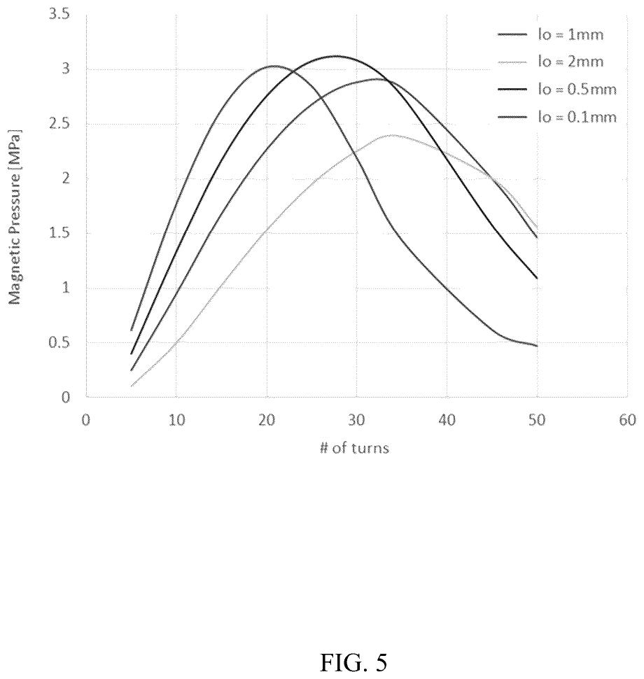

To further highlight this phenomenon, FIG. 5 highlights how the magnetic pressure under a coil 210 placed above a steel plate 214 at four different lift-off heights, injected with 2 kA of current at 20 kHz using the system and processes of the embodiments, changes with increasing number of coil turns. Given constant injection current and number of coil turns, lift-off between the coil 210 and metal workpiece 214 has a significant influence, with increasing lift-off resulting in smaller magnetic pressures. Larger coils are required to generate sufficient pressure with increasing lift-off.

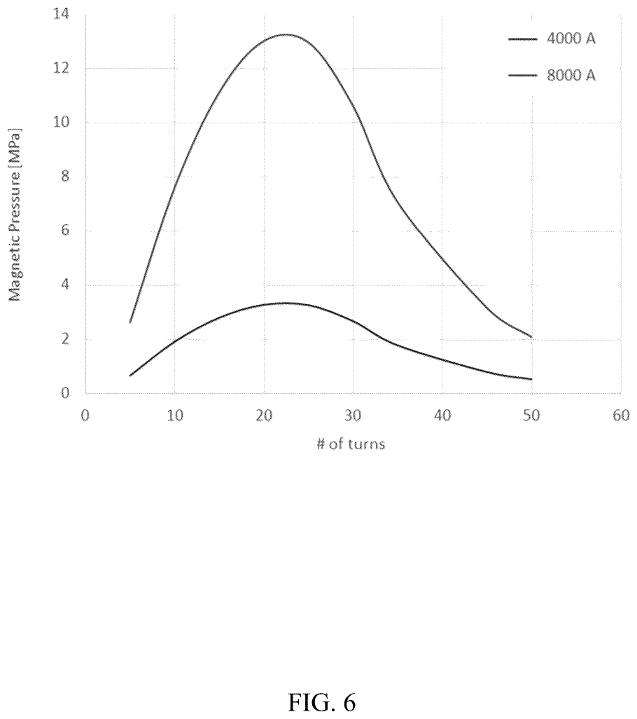

FIG. 6 shows a plot to highlight how the peak pressure generated changes for a coil with injected current using the system and processes of the embodiments. For a given lift-off value, an optimum number of coil turns generates peak pressure. This peak-pressure value can then be increased by increasing the amount of current injected into the coil 210.

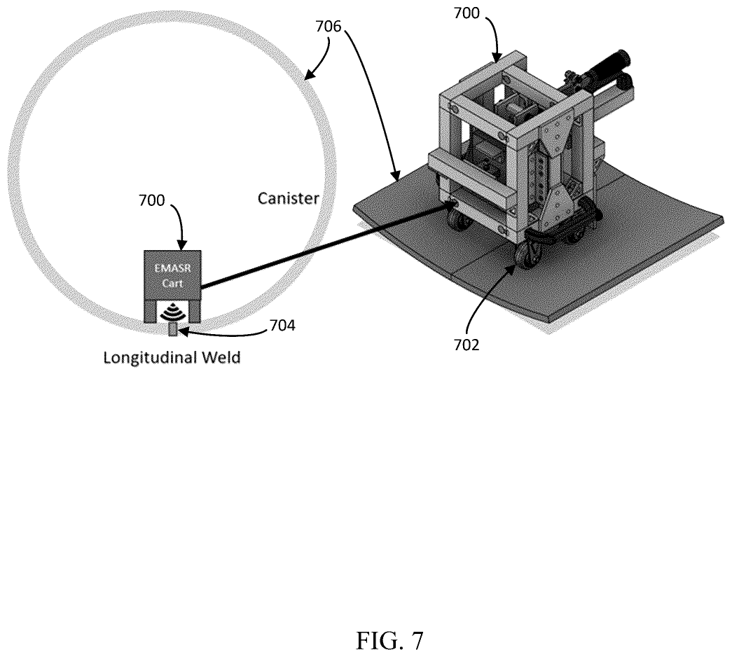

FIG. 7 shows two schematics: the schematic on the left is a plan view of an embodiment for an EM-URSR cart 700 with wheels 702 positioned for processing a longitudinal weld 704 of a DSC canister 706 (weld extends normal to the plane of the page), and the schematic on the right is an isometric view of the plan-view of the EM-URSR cart 700 situated above the longitudinal weld 704 on a DSC 706 section. One embodiment can include an electromagnetic residual stress relieving system, which can include the movable cart 700 to deploy a copper coil above the weld zone 704, and components of the EM-URSR system can include but are not limited to the high-pulsed-current rated capacitor 106, a very high voltage capacitor charger 100, and a spark-gap based circuit 104 to discharge the energy stored in the capacitor into the coil 108. The cart 700 allows for the processing of both longitudinal and axial weld sections of the DSC canister 706.

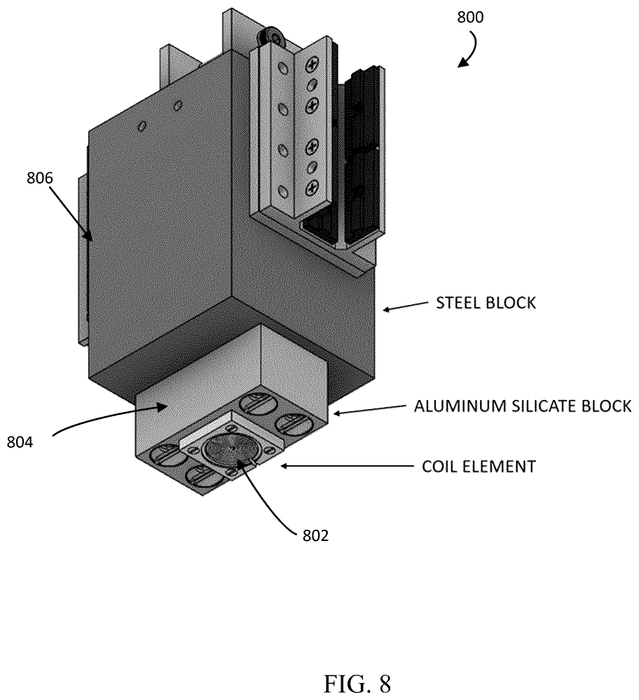

FIG. 8 shows a detailed view of embodiments for a coil element 802 and backing components 804 within the cart 700. The coil 802 can be placed in backing components 804 such as but not limited to a thin slotted alumina silicate ceramic plate and epoxied permanently. The ceramic plate can be fixed to a larger ceramic block which in turn is attached to a steel block 806. The entire block 800 shown in FIG. 8 can be moved vertically into position over the weld zone 704.

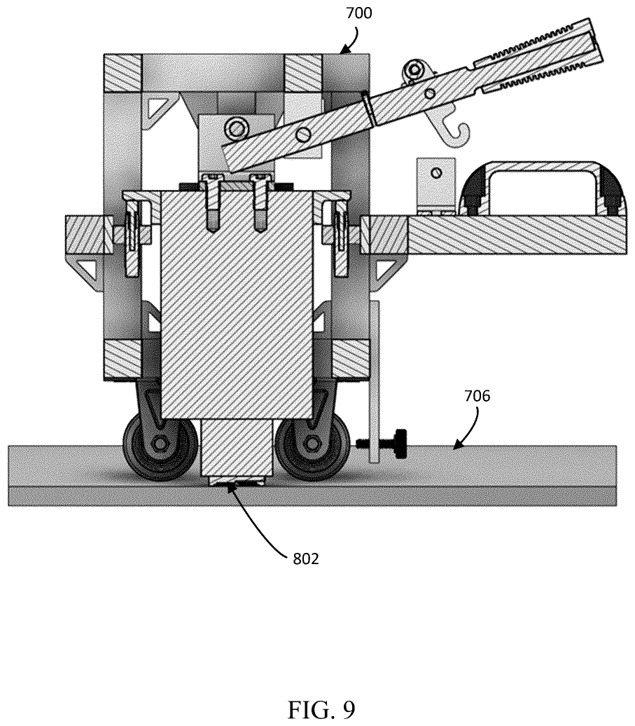

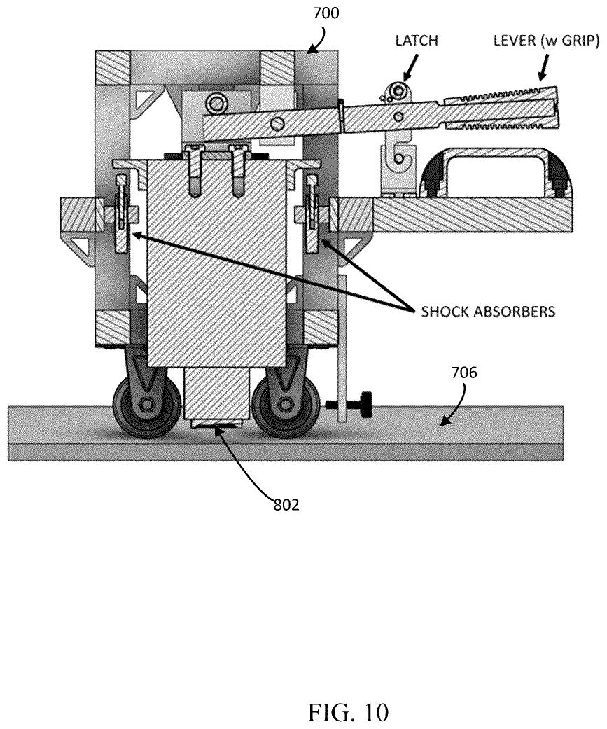

FIG. 9 shows a section view of an embodiment for the cart assembly 700 resting on a DSC canister wall 706 with the coil 802 in a retracted position. FIG. 10 shows a section view of an embodiment for the cart assembly 700 of FIG. 9 with the coil 802 in lowered position. During the reliving process, the coil 802 can be lowered to treat a specific location on the DSC wall 706, pulled up after, and the cart 700 moved to a new location on the DSC wall 706 where the coil 802 can be lowered again.

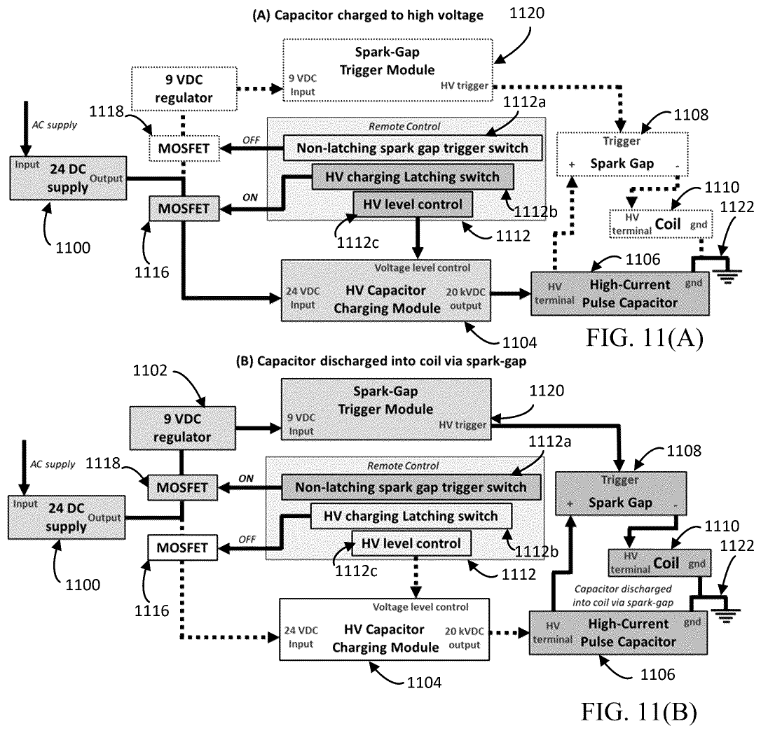

FIGS. 11(A) and 11(B) show flow diagrams for exemplary charging and discharging processes for a coil 1110. The exemplary components in FIGS. 11(A) and 11(B) can be similar to or the same as the exemplary components in FIG. 1. The exemplary process can include utilizing exemplary components for a DC voltage power supply 1100, such as but not limited to a 24V DC power supply, MOSFET 1116, MOSFET 1118, 9 VDC spark-gap trigger module 1120, remote control 1112, high voltage capacitor charging module 1104, high-current pulse capacitor 1106, spark gap trigger 1108, coil 1110, and ground 1112. The remote control 1112 can include a non-latching spark gap trigger switch 1112a, a high-voltage charging latching switch 1112b, and a high-voltage level control 1112c.

FIG. 11(A) shows a block diagram highlighting various embodiments of stages within the capacitor 1106 charging process highlighted by solid black lines and blocks with solid fill. The capacitor charging module 1104 can be enabled via the latching switch 1112b housed in the wired remote 1112 which turns on the MOSFET switch 1116 connecting the 24 VDC supply 1100 to the flyback-transformer based, high-voltage, capacitor charging module 1104. The peak voltage output at the charging module 1104 can be controlled using the voltage control module 1112c on the wired remote control 1112. During the charging process, the non-latching switch 1112a used to discharge the energy in the capacitor 1106 into the coil 1110 is disabled.

FIG. 11(B) shows an exemplary block diagram highlighting various embodiments of stages in a capacitor discharging process, i.e. generation of high pulsed current, highlighted by solid black lines and blocks with solid fill. The key to generating very large pulsed current at the coil 1110 is a rapid discharge of the energy in the charged capacitor 1106. This can be achieved by using the triggered spark gap 1108, which is a type of switch that utilizes the breakdown of a gas to create an electrical discharge thereby allowing a large amount of current to flow between two electrodes. This device is designed to initiate the spark at a precise moment by applying a trigger voltage to a third electrode, called the trigger electrode or grid. When the trigger voltage is applied, it ionizes the gas within the gap, reducing its insulation and causing a spark to form between the main electrodes. The HV terminal of the capacitor 1106 is connected to one electrode of the spark gap 1108, while the other electrode is connected to one end of the coil 1110. The other end of the coil is connected to the ground 1122. To discharge the energy the capacitor 1106 into the coil 1110, the non-latching switch 1112a on the wired remote 1112 is held in the ON position. This exemplary process turns on the MOSFET switch 1118 connecting the 24 VDC supply 1100 to the spark-gap trigger module 1120, which is a flyback-transformer based momentary high voltage pulse generator. The output of the spark-gap trigger module 1120 is connected to the trigger electrode on the spark-gap 1108. Application of a high voltage pulse to the trigger electrode on spark-gap 1108 ionizes the gas within the gap, causing a spark to form between the main electrodes. This results in a closed circuit that can include the capacitor 1106, spark gap 1108, and the coil 1110, resulting in the entire energy in the capacitor 1106 to be discharged through the coil 1110 rapidly. The inductance of the coil 1110 (and other stray inductance) along with the capacitance value of the capacitor 1106 (and other stray capacitance) control the frequency of oscillations produced at the coil 1110.

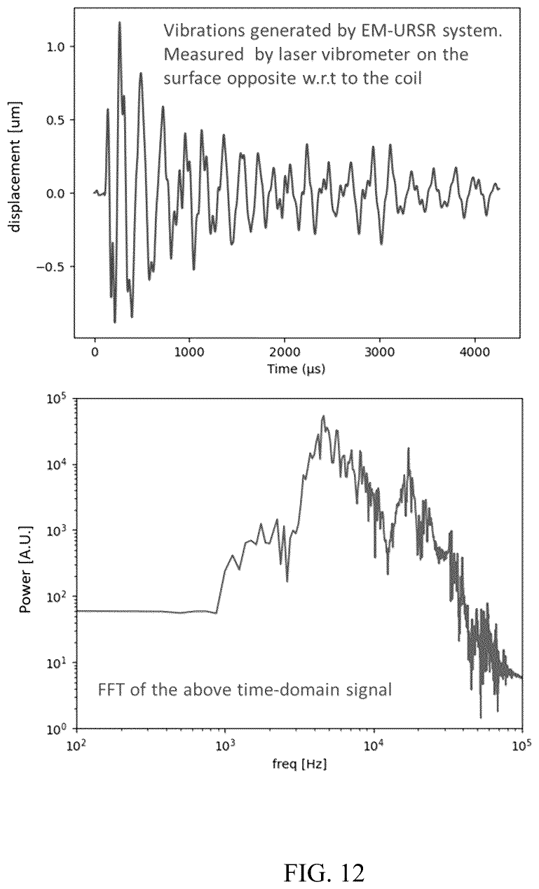

FIG. 12 shows the plots of (top) time and (bottom) frequency domain representation of the signal measured by the laser vibrometer of the through-thickness vibrations generated by the EM-URSR system charged to 9 kV with a 4.5 μF capacitor in ½″-thick steel 304 weld zone. The results indicate 2 μm peak-to-peak displacements on the surface opposite to where the coil was placed. Such large vibrations traveling through the thickness of the plate result in the reduction of the residual stress levels in the weld zone.

While the invention has been described with a certain degree of particularity, it is manifest that many changes may be made in detail of construction and the arrangement of components without departing from the spirit and scope of this disclosure. The present embodiment is to be considered as an exemplification of the invention and is not intended to limit the invention to the specific embodiments herein illustrated by the figures or description above.

What is claimed is:

1. An electromagnetic-based ultrasonic residual stress relief system, comprising:
a capacitor charging module;
a high-pulsed current capacitor that is charged by the capacitor charging module;
a latching switch for high voltage charging that controls current from the from the capacitor charging module to the high voltage capacitor;
a spark-gap trigger module;
a spark-gap trigger circuit;
a non-latching switch for spark-gap trigger that controls current from the spark-gap trigger module to the spark-gap trigger circuit; and
a planar coil,
wherein the high-pulsed current capacitor is charged by the capacitor charging module under control of the latching switch, and
wherein the non-latching switch for spark-gap trigger discharges energy from the high-pulsed current capacitor into the spark-gap circuit, which discharges energy into the coil.

2. The system of claim 1, wherein the non-latching switch for spark-gap trigger discharges the high-pulsed current capacitor up to 20 kV.

3. The system of claim 1, wherein the high-pulsed current capacitor is charged to voltages greater than 10 kV.

4. The system of claim 1, wherein the discharge of energy into the coil generates through-thickness vibrations into a metal surface with a peak-to-peak amplitude of greater than two micrometers.

5. The system of claim 1, wherein the coil is a copper coil that is fixed to a backing component, which is attached to a steel block.

6. The system of claim 1, further comprising a moveable cart, wherein the components of claim 1 are built into the moveable cart for processing welds of a metal surface by moving the coil a distance over a weld and discharging energy from the coil.

7. The system of claim 6, wherein the cart is configured to move the coil over one of a longitudinal and axial weld section of a metal surface.

8. The system of claim 1, wherein the capacitor charging module is connected to a DC power supply and enabled by the latching switch for high voltage charging to charge the high-pulsed current capacitor.

9. The system of claim 1, wherein the non-latching switch connects a DC power supply to the spark-gap trigger module, and the spark-gap trigger module is connected to a trigger electrode on the spark-gap trigger circuit.

10. A process for electromagnetic-based ultrasonic residual stress relief, comprising:
charging a high-pulsed current capacitor by a capacitor charging module under control of a latching switch for high voltage;
controlling current from a spark-gap trigger module to a spark-gap trigger circuit using a non-latching switch for spark-gap trigger,
wherein the non-latching switch for spark-gap trigger discharges energy from the high-pulsed current capacitor into the spark-gap circuit, which discharges energy into the coil.

11. The process of claim 10, wherein the non-latching switch for spark-gap trigger discharges the high-pulsed current capacitor up to 20 kV.

12. The process of claim 10, wherein the high-pulsed current capacitor is charged to voltages greater than 10 kV.

13. The process of claim 10, wherein the discharge of energy into the coil generates through-thickness vibrations into a metal surface with a peak-to-peak amplitude of greater than two micrometers.

14. The process of claim 10, wherein the coil is a copper coil and comprising fixing the copper coil to a backing component, and attaching the backing component to a steel block.

15. The process of claim 10, further comprising processing welds of a metal surface by attaching the coil to a moveable cart, moving the coil a distance over a weld, and discharging energy from the coil.

16. The process of claim 15, further comprising moving the cart moves the coil over one of a longitudinal and axial weld section of a metal surface.

17. The process of claim 10, further comprising connecting the capacitor charging module to a DC power supply and enabling by the latching switch for high voltage charging to charge the high-pulsed current capacitor.

18. The process of claim 10, further comprising connecting the non-latching switch to a DC power supply and to the spark-gap trigger module, and connecting the spark-gap trigger to a trigger electrode on the spark-gap trigger circuit.
